(19) United States
(12) Patent Application Publication
(10) Pub. No.: US 2003/0038152 A1
(43) Pub. Date: Feb. 27, 2003

(54) Flat pack tape dispenser

(76) Inventor: Edward Kaufer, Reno, NV (US)

Correspondence Address: Herbert C. Schulze, 2790 Wrondel Way, PMB36, Reno, NV, 89502, US

(21) Appl. No.: 09/934,007

(22) Filed: Aug. 20, 2001

(51) Int. Cl. B26F 3/02

(52) U.S. Cl. 225/1; 225/7

(57) ABSTRACT

This is a method and apparatus for packaging, transporting and cutting a quantity of Duct Tape in which the tape is formed into a substantially hexahedron shape mounted upon a polyhedron mandrel containing cutting means so configured as to be cooperative with, and useful in, cutting and trimming segments of the tape, wherein the cutting means has auxiliary uses.

### CROSS REFERENCE TO RELATED PATENT APPLICATIONS

This patent application is related to my presently patent applications Ser. No. 09/867,968, filed May 29, 2001, now ______; and Ser. No. 09/800,451, filed Mar. 7, 2001, now ______.

### BACKGROUND OF THE INVENTION

I. Field of the Invention

This invention is in the general field of protective methods and apparatus;

The invention is even more particularly in the general field of useful methods and apparatus for individuals of all levels of physical abilities to assist in overcoming difficult circumstances such as personal endangering situations, property protection, transport convenience and the like.

The invention is most particularly directed a particular product known as “Duct Tape” and a method and apparatus for enhancing its use.

II. Description of the Prior Art

Pressure sensitive tape, and in particular Duct Tape is well known. Duct Tape has been used for many purposes other than its primary intended use in plumbing and the like. For example, outdoors enthusiasts, handy persons, and the like have used Duct Tape for many purposes such as to repair clothing, to reinforce tent seams, to bundle diverse items together for transport, and the like.

However, all such uses contemplate a supply of tape on a roll of some sort. In some cases, people have wound small amounts of Duct Tape from a large roll onto a pencil, or other small object, in order to create a quantity of tape in a more convenient carrying package.

I have searched in the literature, patent files, commercial sources, and the like. I have found no readily useable, durable, and inexpensive device or method for carrying duct tape in an easily packed configuration, with appropriate and easily accessible cutting arrangements. Thus, I have found nothing which I consider to be prior art as to my present invention as is described below.

### SUMMARY OF THE INVENTION

There are numerous situations in which individuals, regardless of their physical prowess, find themselves unable to cope with immediate and temporary emergencies. Such situations include those occasions when a person or an animal may become so unruly as to pose a grave danger to other persons, animals, or property. Such situations have made headlines recently where aircraft have been involved. Without explanation, individuals have become momentarily deranged and have endangered entire planeloads of passengers and cargo. One person under a momentary attack may be capable of holding a large number of others at bay. This can, and does, occur where animals need to be restrained. Also, emergency situations occur where it may be required to restrain cargo against violent movement which might threaten persons or other cargo.

Under emergency circumstances of the nature mentioned, and others, people frequently attempt to restrain objects, persons, and animals with rope, chains, and bare hands. Such attempts are frequently cumbersome and awkward, or may require such great strength and cooridination as to be ineffective.

Also, there are innumerable situations where persons are faced with a requirement for temporary repair, first aid, and the like. Such occurrences, and their solutions using Duct Tape or the like are particularly well known to outdoors persons. Duct Tape has been used for emergency splints, for tent and clothing repair, for shoes, and many other purposes

In most of the situations mentioned above, and in many situations where binding, first aid, improvised repairs, and the like, are required, common Duct Tape can be used for temporary (and sometimes permanent) repair or improvisation. The use of Duct Tape is known to those skilled in various arts including, but not limited to, carpenters, plumbers, electricians, outdoors enthusiasts, and the like. Duct Tape is customarily available in large rolls. This particular characteristic of various ducts tapes and the like causes such tape to be less than fully effective for emergency uses due to the difficulty in carrying and applying such large rolls. Additionally, when a regular roll of duct tape is inadvertently dropped it may roll away, particularly in rugged terrain.

This invention is directed to making Duct Tape easily available and useable under a variety of circumstances. As a first and very important step I have developed a way to convert a roll of tape, or initially form a package of tape into a basically hexahedron shaped package. In one form I also make this package available with a core containing useful tools. Although I have searched through literature, other publications, patents, and the like I have found no prior art as to a convenient way for the average person to carry and utilize Duct Tape for whatever circumstance may arise.

I have now conceived and developed an apparatus and method for convenient and economical packaging, carrying, and using duct tape for all persons and situations. I have done this by constructing a device which carries a variety of cutting and application Duct Tape tools together with a manageable and convenient quantity of Duct Tape.

It is an object of this invention to provide a means for packaging, or altering conventional packaging of conveniently carried and useable quantities of Duct Tape;

It is another object of this invention to provide such means in cooperative relationship with a means to cut convenient lengths of the Duct Tape;

Another object of this invention is to provide such a method for proper utilization of such Duct Tape under adverse conditions;

The foregoing and other objects and advantages of this invention will become apparent to those skilled in the art upon reading the following description of preferred embodiments together with a complete and detailed review of the appended drawings.

### BRIEF DESCRIPTION OF THE DRAWINGS

FIG. 1 is a perspective of what I refer to as a “Flat Pack” of tape having a core containing implements;

FIG. 2 is an exploded view of the core of FIG. 1;

FIG. 3 is a side elevation of a “Flat Pack” of tape having a different core than that of FIG. 1;

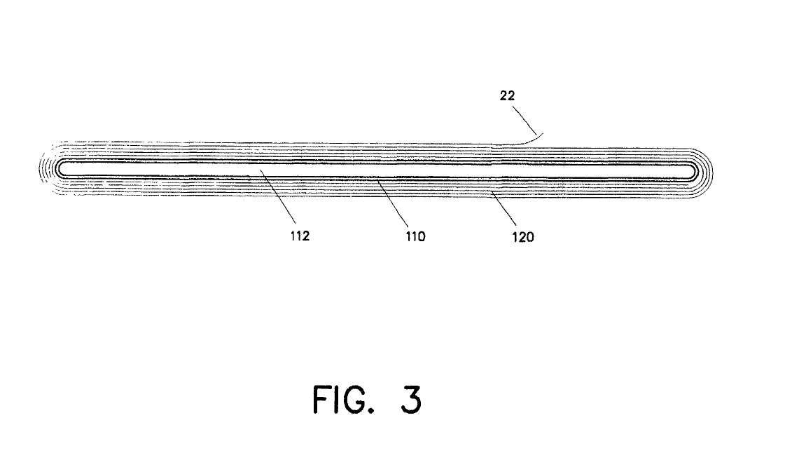

FIG. 4 is a top elevation of the core of FIG. 3; and

FIG. 5 is an exploded view of the core of FIG. 3.

### DESCRIPTION OF A PREFERRED EMBODIMENT

An inventory of the items bearing reference numerals on the drawings is:

| Numeral | Identification of item |
|---|---|
| 10 | hollow tape core |
| 12 | interior of core |
| 13 | cutting instrument |
| 14 | knife edge |
| 15 | handle |
| 16 | cutting instrument |
| 17 | serrated edge |
| 18 | cutting instrument enlarged edge |
| 19 | hook |
| 19a | hook |
| 22 | tape edge |
| 110 | core |
| 112 | hollow interior of core |
| 113 | hinge boss |
| 114 | holes in hinge boss |
| 115 | hinge pin |
| 117 | hole in cutting instrument arm |
| 118 | cutting instrument |
| 119 | cutting instrument in phantom carrying position |
| 122 | serrated edge |
| 123 | cutting instrument in intermediate position |
| 124 | shaped arm |
| 140 | scissors in position for use |

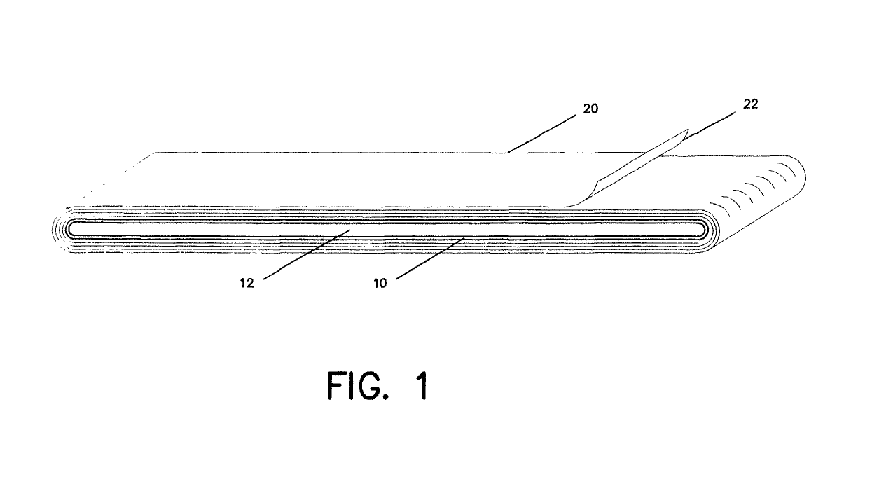

The tape as customarily supplied is in a roll wrapped around a paper or cardboard core. I have found that I am able to press the outside of the roll of tape between two flat parallel surfaces such as the jaws of a large vice or the like and compress a round roll of tape and its core into the configuration shown in FIG. 1 where the core has become an elongated polyhedron 10 with a hollow interior 12. The tape has become flattened out as shown (I refer to the tape formed in this manner as a “flat pack” of tape). I am also able to accomplish this by forming the core into this shape first and then winding the tape around it. A leading edge of the tape 22 may be pulled in order to take a desired length of tape from the flat pack.

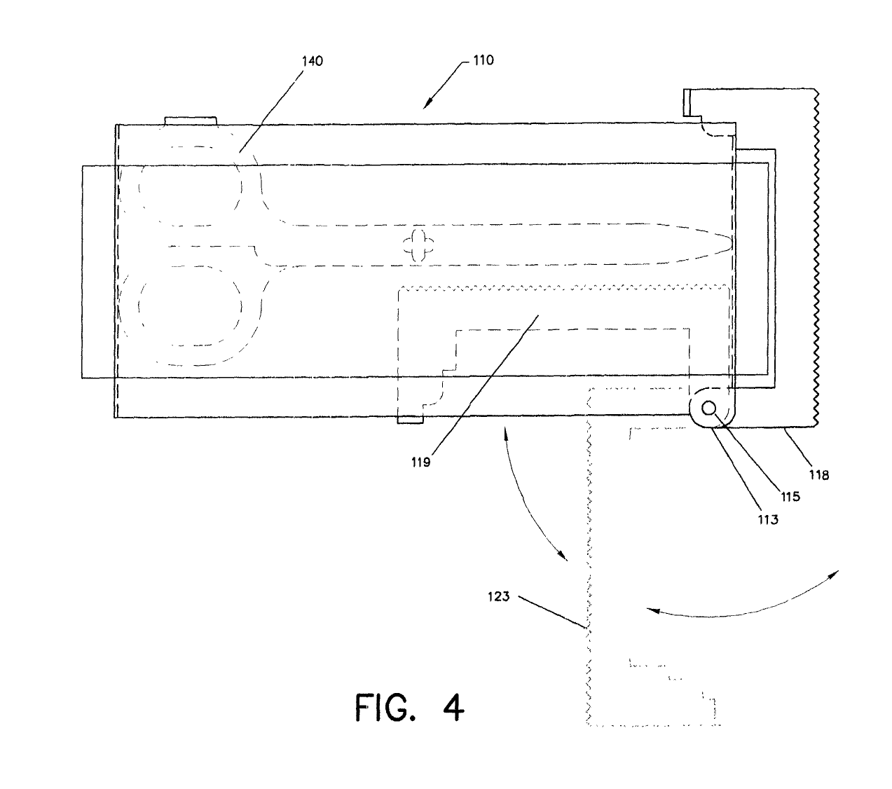

A cutting device core 110 may be inserted into the interior of the core and is dimensioned so that it can fit snuggly within the space 12, but it will be wider as is clear in FIG. 4. It is necessary to be wider in order for the cutting blade 118 to be pivoted out from its storage and transport position as shown by phantom 123 and 19 to the position of use as shown in FIG. 4.

The operation will be that a length of tape will be pulled off of the flat pack, the cutter 118 will be moved out from its storage position to the cutting position, the length of tape will be cut, and the cutter will be moved either to the intermediate position or to its storage position until the next length of tape is desired.

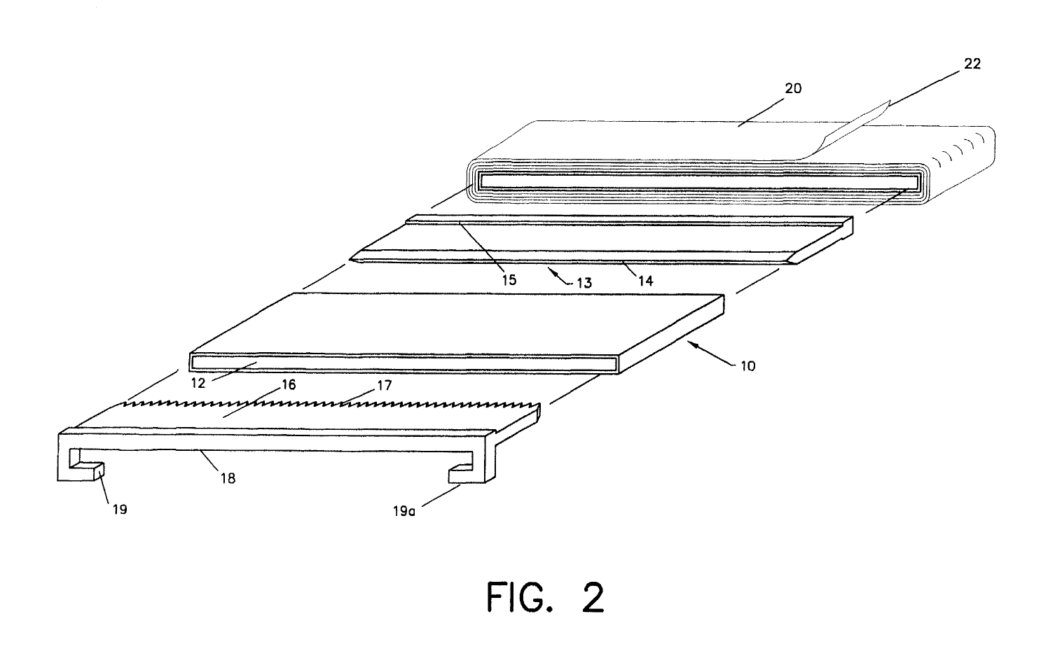

Two different type cutting devices are shown in FIG. 2. Cutting instrument 13 has elongated knife edge 14 which may be useful for a variety of purposes. It has a convenient handle 15.

Cutting instrument 16 has a serrated edge 17 and an enlarged edge 18 with two hook-like appendages 19 and 19a. The appendages make it possible to hook over a ledge or the like for ease of use.

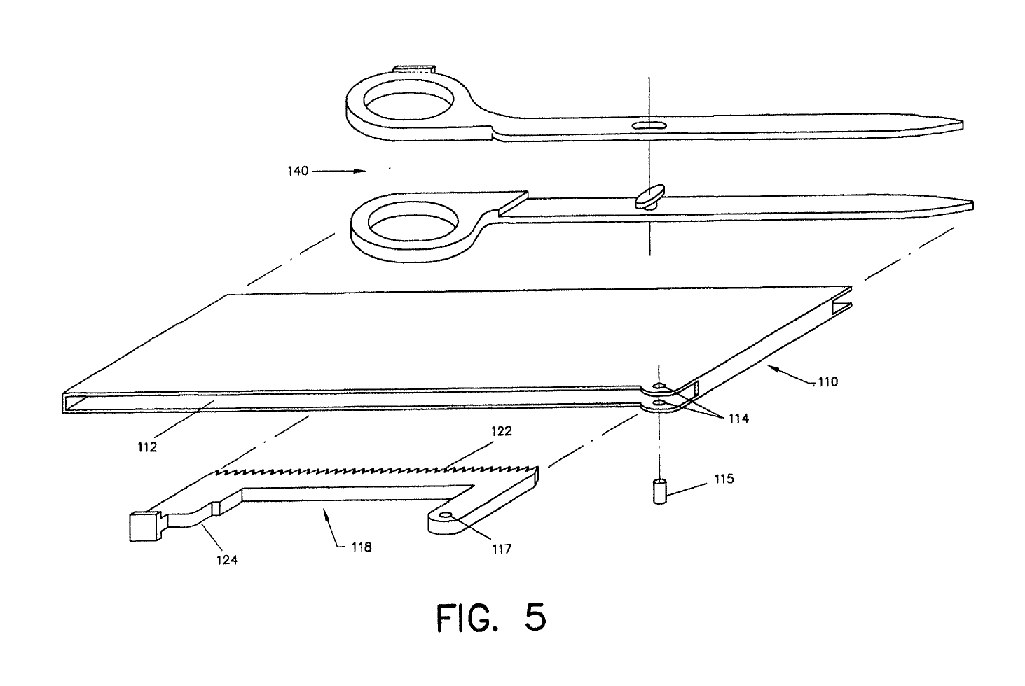

The most preferred form of this device is shown in FIGS. 4 and 5. The core 110 has a hollow interior 112 and a pair of hinge bosses 113. Cutting instrument 118 has a hole 117. When assembled with hinge pin 115 and moved to the position shown in FIG. 4, the tape shown by the two ends extending over the core in FIG. 4 is easily cut on the serrated edge 122. The specially shaped arm 124 is held in position as shown in figure when in use. A scissors 140 is shown in phantom in FIG. 4 and dissembled in FIG. 5.

The scissors may be held in the container by friction, or they may be held by various locking means as will be understood by those skilled in the art. The scissors is made of two handle/blade combinations as shown in FIG. 5. which can be detached as shown or fastened together by connector 24 being inserted into connector slot 23. When connected, the scissors can be used in a customary manner. When detached, each handle/blade unit can be used as a knife and for a variety of other purposes. Each handle/blade can be driven into a tree or some other object and can be used to hang such items as food and water above ground to protect them from animals and insects. Also, these handle/blades can be driven into the ground and used for tie pegs. Numerous other uses can be made of these detachable items. Among other things, the scissors can be invaluable in making a snow cave if one is trapped in a blizzard or the like.

I claim:

1. A method for utilization of Duct Tape comprising: winding an elongate length of Duct Tape upon a hollow polyhedron mandrel which mandrel contains a swivel mounted tape cutting tool; moving the swivel mounted tape cutting tool into a position such that a portion of the Duct Tape may be severed by pressure against the cutting tool; unwinding a portion of the elongate length of Duct Tape from the mandrel; severing the portion of Duct Tape by pressure against the cutting tool; and utilizing the severed portion of Duct Tape.

2. The method of claim 1 wherein the utilization of the severed portion of Duct Tape includes trimming said tape by use of a trimming scissors carried by said mandrel.

3. Apparatus for transporting Duct Tape comprising: a hollow polyhedron mandrel; a tape cutting blade mounted within said hollow polyhedron mandrel in such manner that the blade may be swiveled to a position wholly within said mandrel or to a position exterior of said mandrel for use in cutting tape.

4. The apparatus of claim 3 wherein an auxiliary tape cutting device is cooperatively mounted within said mandrel and adjacent said cutting blade.

5. A utility cutting instrument comprising: a first tool comprising a first handle having means to suspend an article connected to a first elongate blade; a second tool comprising a second handle having means to suspend an article connected to a second elongate blade; and means detachably connecting said first and second tools.

6. The method of creating a flat pack of duct tape comprising: placing a customary roll o duct tape between two parallel flat surfaces; moving said surfaces toward one another until the space between the flat surfaces and the exterior of the tape achieve essentially hexahedron shapes; and removing said flat surface from the flat pack of tape.
